(19) United States
(12) Patent Application Publication
(10) Pub. No.: US 2009/0112707 A1
(43) Pub. Date: Apr. 30, 2009

(54) METHOD AND SYSTEM FOR USING A POINT-OF SALE SYSTEM TO CORRELATE TRANSACTIONS TO A COUPON DATABASE

(76) Inventors: Benjamin Weiss, Portola Valley, CA (US); Miriam Geller, San Francisco, CA (US)

Correspondence Address: GUNNISON, MCKAY & HODGSON, L.L.P., 1900 GARDEN ROAD, SUITE 220, MONTEREY, CA, 93940, US

(21) Appl. No.: 11/925,180

(22) Filed: Oct. 26, 2007

(51) Int. Cl. G06Q 30/00; G06F 17/30; G06F 17/40

(52) U.S. Cl. 705/14

(57) ABSTRACT

A system and method for providing relevant coupons at the point of sale includes a process for providing relevant coupons at the point of sale whereby a coupon database is provided with at least a portion of the coupon database, and the coupon data in that portion, being associated with a given user. Electronic data representing one or more coupons, and/or other marketing devices, associated with, and/or offered to, the given user is then provided to the coupon database and stored in the portion of the database associated with the user. A computing system implemented point-of-sale system is then given access to the coupon database and/or the portion of the database associated with the user at the time of a transaction being made through the computing system implemented point-of-sale system. Data and/or search parameters from the computing system implemented point-of-sale system are then used to search the portion of the database associated with the user to find any relevant coupons applicable to the user's current transaction. Any relevant coupons are then provided to the user and/or are automatically applied to the current transaction.

### BACKGROUND

Many providers of consumer goods and services offer coupons, and/or other marketing devices such as discount certificates and vouchers, to consumers in an effort to attract and/or encourage business. Many coupons offer significant discounts to the consumer holding, and meeting the terms of, the coupon. Typically, the coupon provider is willing to provide these discounts to the consumer to meet specific coupon provider goals, including, but not limited to: to help build up a customer base; to get consumers into a store; to retain customers who might find a lower price for an item from a competitor; to lure customers away from a competitor; and/or to help clear excess inventory and/or to boost sales of a given product.

Traditionally, coupons have been distributed in “hard-copy”, typically printed, form by various means, including, but not limited to: by mail; in newspapers; in magazines; in flyers and inserts; at store front and/or product displays; and/or as attachments to store receipts (i.e., printed on the back of a receipt or appended to a receipt). More recently, coupons have been offered by and/or through various computing system implemented financial management systems, such as a computing system implemented personal financial management system, and/or using electronic means such as, but not limited to: networks of computing systems, including public networks such as the Internet; through and/or on web-sites; by e-mail; as electronic coupon attachments to electronic receipts; as electronic coupon attachments to transactional data, such as, but not limited to transactional data from and/or displayed by a computing system implemented financial management system, banks, credit card companies, and other financial institutions; and/or as an electronic coupon attachment to virtually any electronic document and/or data.

Currently, both traditional “hard-copy” coupon distribution methods and coupon distribution methods, by and/or through, electronic means, including through computing system implemented financial management systems, typically rely on a resultant printed copy, or other hard-copy, of the coupon. Consequently, using currently available coupon distribution means a consumer must: search and actually find a relevant coupon offer; obtain the hard-copy of the coupon, either by cutting it out of a printed document or printing a copy out on a printer; save/store the hard copy of the coupon until needed; and make sure they have the hard copy of the coupon with them when they actually attempt to purchase the subject product and/or service at the store. All too often, this chain of required events associated with currently available coupon distribution methods is far too complicated and time consuming for the consumer and is often broken by a lost or forgotten coupon or some other similar event.

Consequently, millions of dollars in unclaimed coupon saving go unused each year. This represents not only a significant disservice to consumers, but also means that the goals of the coupon providers that led the coupon providers to offer the coupon in the first place are also often unmet.

### SUMMARY

In accordance with one embodiment, a system and method for providing relevant coupons at the point of sale includes a process for providing relevant coupons at the point of sale whereby a coupon database is provided with at least a portion of the coupon database, and the coupon data in that portion, being associated with a given user. Electronic data representing one or more coupons, and/or other marketing devices, associated with, and/or offered to, the given user is then provided to the coupon database and stored in the portion of the database associated with the user. In one embodiment, a computing system implemented point-of-sale system is then given access to the coupon database and/or the portion of the database associated with the user. In one embodiment, data and/or search parameters from the computing system implemented point-of-sale system are then used to search the portion of the database associated with the user to find any relevant coupons applicable to the user's current transaction being conducted through the computing system implemented point-of-sale system. In one embodiment, any relevant coupons are provided to the user and/or are automatically applied to the current transaction.

In one embodiment, a coupon database is provided with at least a portion of the coupon database, and the coupon data in that portion, being associated with a given user. In one embodiment, the coupon database is a data storage device, a designated server system or computing system, or a designated portion of one or more server systems or computing systems, a mobile computing system, a server system network, a distributed database, or an external and/or portable hard drive. In one embodiment, the coupon database is a dedicated mass storage device implemented in software, hardware, or a combination of hardware and software. In one embodiment, the coupon database is a web-based function. In one embodiment, the coupon database is part of, or under the control of, any computing system, including, but not limited to, a desktop computing system; a laptop computing system; a cellular telephone, a smart phone, a digital wireless telephone, a Personal Digital Assistant (PDA), a hand held computer, any portable computer, any portable workstation, a two-way pager, any Internet appliance/device, or any other device, or any desired combination of devices, that includes a capability for receiving and/or storing data whether known at the time of filing or as developed thereafter.

In one embodiment, electronic data representing one or more coupons, and/or other marketing devices, is provided to the coupon database through, from, and/or using, a computing system implemented financial management system that implements, includes, is accessed by, and/or is otherwise associated with, the process for providing relevant coupons at the point of sale and/or the coupon database. In one embodiment, the computing system implemented financial management system can be, but is not limited to, any of the following: a computing system implemented personal financial management system; a computing system implemented home inventory system; a computing system implemented business inventory system; a computing system implemented point-of-sale system; a computing system implemented personal asset management system; a computing system implemented business asset management system; a computing system implemented personal accounting system; a computing system implemented business accounting system; a computing system implemented tax preparation system; and/or any of the numerous computing system implemented financial management systems known to those of skill in the art at the time of filing or as developed thereafter.

In one embodiment, the electronic data representing one or more coupons, and/or other marketing devices, is provided to the coupon database either directly, or through a computing system implemented financial management system, from one or more computing systems and/or databases where the electronic data representing one or more coupons, and/or other marketing devices, are stored and/or categorized.

In one embodiment, a computing system implemented point-of-sale system is provided. Computing system implemented point-of-sale systems are typically used by product and/or service providers, such as retailers, to conduct business transactions and perform various sales functions, including, but not limited to, any of the following: cash register functions; generate receipts; categorize transactions; interface with inventory and/or accounting modules/applications; and/or create and/or store detailed transactional data regarding sales for accounting and/or tax purposes. In one embodiment, the computing system implemented point-of-sale system is any one of numerous computing system implemented point-of-sale systems currently available that has the ability, and/or is modified to have the ability, to link and/or communicate with the coupon database at the point of sale.

In one embodiment, when a given user is at the point of sale and his or her transaction is being processed by the computing system implemented point-of-sale system, the computing system implemented point-of-sale system is given access to the coupon database and/or the portion of the database associated with the user. In one embodiment, the computing system implemented point-of-sale system is given access to the electronic data representing one or more coupons, and/or other marketing devices, in the coupon database either directly, or, in one embodiment, through a computing system implemented financial management system, via a network connection, such as a wired or wireless Internet connection or other network connection, known at the time of filing or as developed thereafter.

In one embodiment, the user is identified by the point of sale system by any one of numerous methods, including, but not limited to: a card, and/or key chain device, and/or other mechanism, associated with the user and/or issued by the provider of products and/or services implementing and/or operating the computing system implemented point-of-sale system; all or part of the account number on the user's credit and/or debit card, or other device, being used to pay for the transaction; all or part of the user's telephone number, or similar unique identification number, as supplied by the user, in one embodiment through a user interface device such as a keypad and/or touch screen, and, in one embodiment, at the point of sale; using a Personal Identification Number (PIN), or similar mechanism, provided by the user, in one embodiment, at the point of sale, and, in one embodiment through a user interface device such as a keypad and/or touch screen; and/or any other mechanism, known at the time of filing or as developed thereafter, for identifying a user.

In one embodiment, data and/or search parameters are then used to search the portion of the coupon database associated with the user to find any relevant coupons applicable to the user's current transaction being conducted through the computing system implemented point-of-sale system. In one embodiment, the data and/or search parameters are defined by the computing system implemented point-of-sale system. In one embodiment, the data and/or search parameters are defined by the process for providing relevant coupons at the point of sale. In one embodiment, the data and/or search parameters are defined by the provider of products and/or services implementing and/or operating the computing system implemented point-of-sale system. In one embodiment, the data and/or search parameters are defined by provider of the coupon database. In one embodiment, the data and/or search parameters are defined by coupon provider. In one embodiment, the data and/or search parameters are defined by user. In one embodiment, the data and/or search parameters are defined by any third party. In one embodiment, the data and/or search parameters are defined by any combination of the above parties.

In one embodiment, any relevant coupons found as a result of the search of the coupon database are provided and/or submitted to the user, and/or the provider of products and/or services implementing and/or operating the computing system implemented point-of-sale system, for approval prior to being applied to the current transaction. In one embodiment, any relevant coupons found as a result of the search of the coupon database are automatically applied to the current transaction.

Using the system and method for providing relevant coupons at the point of sale disclosed herein, electronic data representing one or more coupons, and/or other marketing devices, is stored in a coupon database and/or the portion of a coupon database associated with the user. The coupon database and/or the portion of a coupon database associated with the user is then made available to a computing system implemented point-of-sale system, in one embodiment, at the point of sale for use with a transaction currently being conducted through the computing system implemented point-of-sale system. Therefore, using the system and method for providing relevant coupons at the point of sale disclosed herein, the consumer can obtain, and use, electronic coupons relating to their purchases virtually anytime and anywhere. As result, the system and method for providing relevant coupons at the point of sale disclosed herein, spares the consumer: the process of searching for a relevant coupon; the need to obtain a hard-copy of the coupon, either by cutting it out of a printed document or printing a copy out on a printer; the need to save/store the hard copy of the coupon until used; and the need to carry with them, and supply, the hard copy of the coupon when they actually attempt to make a purchase. As a result, using a system and method for providing relevant coupons at the point of sale disclosed herein, the consumer is more likely to benefit from coupon offers and the goals of the coupon providers are also more likely to be met.

As discussed in more detail below, using the below embodiments, with little or no modification and/or user input, there is considerable flexibility, adaptability, and opportunity for customization to meet the specific needs of various users under numerous circumstances.

### BRIEF DESCRIPTION OF THE DRAWINGS

FIG. 1 is a block diagram of an exemplary hardware architecture for implementing one embodiment; and

FIG. 2 is a flow chart depicting a process for providing relevant coupons at the point of sale in accordance with one embodiment.

Common reference numerals are used throughout the FIGS. and the detailed description to indicate like elements. One skilled in the art will readily recognize that the above FIGS. are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIGS., which depict one or more exemplary embodiments. Embodiments may be embodied in many different forms and should not be construed as limited to the embodiments set forth herein, shown in the FIGS., and/or described below. Rather, these exemplary embodiments are provided to allow a complete disclosure that conveys the principles of the invention, as set forth in the claims, to those of skill in the art.

For illustrative purposes, some embodiments are described herein within the framework of, and using, one or more computing system implemented financial management systems. Various specific details are discussed below, and shown in the accompanying FIGS., to aid one of skill in the art in understanding the invention. However, such specific details are intended to be illustrative only, and are not intended to restrict in any way the scope as claimed herein. In addition, the particular terminology used herein is intended to be illustrative and exemplary only, and in no way limits the scope as claimed.

Some embodiments are implemented in a computing system including a conventional computing system running a conventional operating system such as those distributed by Microsoft Corporation of Redmond Wash.; Apple Computer Inc. of Cupertino Calif.; any Unix operating system; any Linux operating system; the Palm OS series of operating systems; or any other operating system designed to generally manage operations on a computing system, whether known at the time of filing or as developed later. Some embodiments are implemented in a mobile computing system running mobile operating systems such as Symbian® OS, Windows® Mobile, or any other operating system designed to generally manage operations on a mobile computing system, whether known at the time of filing or as developed later. As described more fully below, embodiments can be implemented on computing systems other than a conventional computing system such as, for example, a personal digital assistant, a cell phone, or other computing system capable of processing computer readable data, whether known at the time of filing or as developed later. Computing systems also include those in which one or more computing resources (hardware or software) are located remotely and accessed via network, such as a Local Area Network (LAN), Wide Area Network (WAN), a public network, such as the Internet, a private network, a combination of network types, a computing system bus, or other electronic medium in which data may be exchanged between one computing system and one or more other computing system(s), whether known at the time of filing or as developed later. Embodiments may be included as add-on software for existing software programs, packages or applications, and embodiments may be a feature of an application that is bundled with a computing system or sold separately. Some embodiments may also be implemented as functionality embedded in hardware devices and systems.

Output generated by one or more embodiments can be displayed on a display screen, delivered from a website and/or web-based function, transmitted to a remote device, stored on any database, computer server or other storage mechanism, printed, or used in any other way. In addition, in some embodiments, processes and/or systems described herein may make use of input provided to the computer device implementing a process and/or application, discussed herein, via user interface devices such as a keyboard, mouse, touchpad, or any other device capable of providing user input to a computing system or for translating user actions into computing system operations, whether known at the time of filing or as developed later.

### Hardware System Architecture

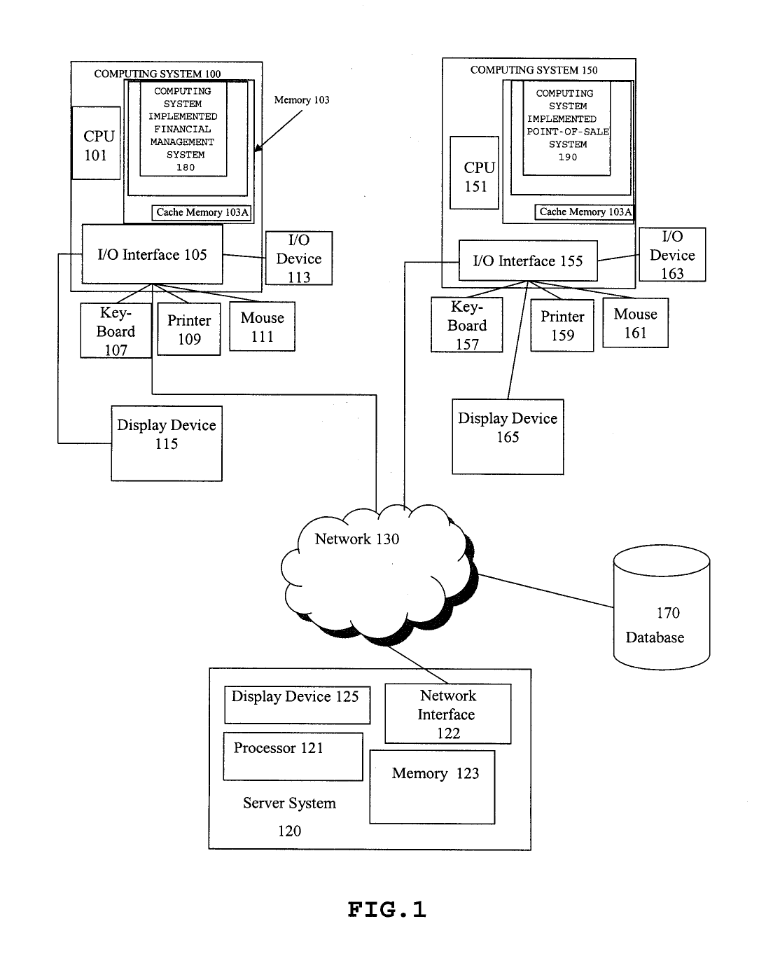

FIG. 1 is a block diagram of an exemplary hardware architecture for implementing one embodiment of a system and method for providing relevant coupons at the point of sale, such as exemplary process 200 discussed herein, that includes: a computing system 100, e.g., a first computing system; a computing system 150, e.g., a second computing system, in one embodiment, a point of sale computing system; a server system 120; and a database 170, all operatively coupled by a network 130.

As seen in FIG. 1, computing system 100 typically includes a central processing unit (CPU) 101, an input/output (I/O) interface 105, and a memory system 103, including cache memory 103A. In one embodiment, memory system 103 includes all, or part of, a computing system implemented financial management system 180 such as, but not limited to: a computing system implemented personal financial management system; a computing system implemented business financial management system; a computing system implemented personal accounting system; a computing system implemented business accounting system; a computing system implemented tax preparation system; a computing system implemented healthcare management system; or any other computing system implemented personal and/or business data management system. In one embodiment, computing system implemented financial management system 180 is stored, in whole, or in part, in memory system 103, and is used by, associated with, or includes, as discussed below, a process for providing relevant coupons at the point of sale, such as exemplary process 200 discussed below.

Computing system 100 may further include standard user interface devices such as a keyboard 107, a mouse 111, a printer 109, and a display device 115, as well as, one or more standard input/output (I/O) devices 113, such as a compact disk (CD) or Digital Video Disc (DVD) drive, floppy disk drive, or other digital or waveform port, or other device capable of inputting data to, and outputting data from, computing system 100, whether available or known at the time of filing or as later developed. As discussed in more detail below, in one embodiment, a process for providing relevant coupons at the point of sale and/or a computing system implemented financial management system are entered, in whole, or in part, into computing system 100 via I/O device 113, such as from a CD, DVD, floppy disk, portable hard drive, memory stick, download site, or other medium and/or computer program product as defined herein.

In one embodiment, computing system 100 is a computing system used, at least in part, as a coupon database and data representing one or more coupons associated with a user is stored in computing system 100, typically in one or more accounts associated with the user. In one embodiment, computing system 100 is a computing system used and/or accessible by another computing system, such as computing system 150 (discussed below), a cellular telephone, a smart phone, a digital wireless telephone, a Personal Digital Assistant (PDA), a two-way pager, a mobile server computer, an Internet appliance, any other device, or any desired combination of these devices, that includes components that can execute all, or part, of a process for providing relevant coupons at the point of sale, in accordance with at least one of the embodiments as described herein.

In one embodiment, computing system 150 can include a CPU 151, an input/output (I/O) interface 155, and a memory system 153, including cache memory 153A. In one embodiment, computing system 150 may further include standard user interface devices such as a keyboard 157, a mouse 161, a printer capability 159, and a display device 165, as well as, one or more standard input/output (I/O) devices 163, such as a compact disk (CD) or DVD drive, floppy disk drive, or other digital or waveform port, or other device capable of inputting data to, and outputting data from, computing system 150, whether available or known at the time of filing or as later developed. In one embodiment, computing system 150 is a point of sale computing system.

In one embodiment, memory system 153 includes all, or part of, a computing system implemented point-of-sale system 190. In one embodiment, computing system implemented point-of-sale system 190 is used by product and/or service providers, such as retailers, to conduct business transactions and perform various sales functions, including, but not limited to, any of the following: cash register functions; generate receipts; categorize transactions; interface with inventory and/or accounting modules/applications; and/or create and/or store detailed transactional data regarding sales for accounting and/or tax purposes. In one embodiment, computing system implemented point-of-sale system 190 is any one of numerous computing system implemented point-of-sale systems currently available that has the ability, and/or is modified to have the ability, to link and/or communicate with a coupon database.

In one embodiment, computing system 150 is a computing system used, at least in part, as a coupon database and data representing one or more coupons associated with a user is stored in computing system 150, typically in one or more accounts associated with the user. In one embodiment, all, or part of: electronic data representing one or more coupons, and/or other marketing devices; a process for providing relevant coupons at the point of sale; and/or a computing system implemented financial management system, can be loaded, in whole, or in part, into computing system 150 from computing system 100 and/or another data source, for storage in memory system 153 and/or cache memory 153A.

Also shown in FIG. 1 is exemplary database 170. In one embodiment, database 170 is a data storage device, a designated server system or computing system, or a designated portion of one or more server systems or computing systems, such as computing system 100, computing system 150, and/or server system 120, or a distributed database, or an external and/or portable hard drive. In one embodiment, database 170 is a dedicated mass storage device implemented in software, hardware, or a combination of hardware and software. In one embodiment, database 170 is a web-based function. In one embodiment, database 170 is used, at least in part, as a coupon database and data representing one or more coupons associated with a user is stored in database 170, typically in one or more accounts associated with the user. As discussed in more detail below, in one embodiment, database 170 is under the control of the user, and/or the user's agents, and/or a process for providing relevant coupons at the point of sale, such as exemplary process 200, and/or a computing system implemented process, such as a computing system implemented financial management system 180 and/or a computing system implemented point-of-sale system 190.

In one embodiment, database 170 is used, controlled, and/or accessible by, a provider of a system and process for providing relevant coupons at the point of sale, such as process for providing relevant coupons at the point of sale 200, and all, or part, of the electronic data representing one or more coupons, and/or other marketing devices, is stored in database 170. In one embodiment, database 170 is used, controlled, and/or accessible by, a provider of a computing system implemented financial management system, such as a computing system implemented financial management system 180, and all, or part, of the electronic data representing one or more coupons, and/or other marketing devices, is stored in database 170. In one embodiment, database 170 is used, controlled, and/or accessible by, one or more coupon and/or marketing device providers and all, or part, of the electronic data representing one or more coupons, and/or other marketing devices, is stored in database 170.

In one embodiment, computing systems 100 and 150, and database 170, are coupled to a server system 120 through network 130. In one embodiment, server system 120 typically includes a server system display device 125, a server system processor 121, a server system memory 123, and a server system network interface 122.

In one embodiment, server system 120 is used, at least in part, as a coupon database and data representing one or more coupons associated with a user is stored in server system 120, typically in one or more accounts associated with the user.

In one embodiment, server system 120 is used in a station-to-station arrangement, such as a peer-to-peer, or hybrid peer-to peer, arrangement, as an indexing and/or central server used to connect a first computing system, such as computing system 100, and a second computing system, such as computing system 150.

In one embodiment, server system 120 is used, controlled, and/or accessible by, a provider of a system and process for providing relevant coupons at the point of sale, and/or a system and process for providing relevant coupons at the point of sale, such as process for providing relevant coupons at the point of sale 200, and all, or part, of the electronic data representing one or more coupons, and/or other marketing devices, is stored in server system 120. In one embodiment, server system 120 is used, controlled, and/or accessible by, a provider of computing system implemented financial management system, and/or a computing system implemented financial management system, such as a computing system implemented financial management system 180, and all, or part, of the electronic data representing one or more coupons, and/or other marketing devices, is stored in server system 120. In one embodiment, server system 120 is used, controlled, and/or accessible by, one or more coupon and/or marketing device providers and all, or part, of the electronic data representing one or more coupons, and/or other marketing devices, is stored in server system 120.

Network 130 can be any network or network system that is of interest to a user such as, a peer-to-peer network, a hybrid peer-to-peer network, a Local Area Network (LAN), a Wide Area Network (WAN), a public network, such as the Internet, a private network, a combination of different network types, or any other wireless, wired, and/or a wireless and wired combination networks capable of allowing communication between two or more computing systems, whether available or known at the time of filing or as later developed.

Those of skill in the art will readily recognize that the components shown in FIG. 1, such as computing system 100 and computing system 150, database 170, server system 120, and their respective components, are shown for illustrative purposes only and that architectures with more or fewer components can implement, and benefit from, the invention. Moreover, one or more components of computing system 100, computing system 150, database 170, and server system 120 may be located remotely from their respective system and accessed via network, as discussed herein. In addition, the particular type of, and configuration of, computing system 100, computing system 150, database 170, and server system 120 are not relevant.

As discussed in more detail below, in one embodiment, a process for providing relevant coupons at the point of sale, such as process for providing relevant coupons at the point of sale 200, and/or a computing system implemented financial management system, such as computing system implemented financial management system 180, and/or a computing system implemented point-of-sale system, such as computing system implemented point-of-sale system 190, and/or data representing coupons and/or other marketing devices, are stored, in whole, or in part, in memory system 103 and/or cache memory 103A, of computing system 100, and/or memory system 153 and/or cache memory 153A of computing system 150, and/or in server memory system 123 of server system 120 and/or in database 170, and executed on computing system 100 and/or computing system 150. As used herein, a memory refers to a volatile memory, a non-volatile memory, or any combination of the two.

Although a process for providing relevant coupons at the point of sale, such as process for providing relevant coupons at the point of sale 200, and/or a computing system implemented financial management system, such as computing system implemented financial management system 180, and/or computing system implemented point-of-sale system, such as computing system implemented point-of-sale system 190, are sometimes referred to herein, alternatively, as a process, an application, a module, a program, a component of a software system, a component of a software package, a component of a parent system, a plug-in, or a feature of a parent system, this terminology is illustrative only. In some embodiments, a process for providing relevant coupons at the point of sale, such as process for providing relevant coupons at the point of sale 200, and/or a computing system implemented financial management system, such as a computing system implemented financial management system 180 and/or a computing system implemented point-of-sale system, such as computing system implemented point-of-sale system 190, are capable of being called from an application or the operating system. In one embodiment, an application, process, or program is generally defined to be any executable code. Moreover, those of skill in the art will understand that when it is said that an application, process, or an operation takes some action, the action is the result of executing one or more instructions by a processor, such as CPUs 101 and 151, or server system processor 121. In one embodiment, execution of a process by CPU 101, CPU 151, or server system processor 121, results in the operations of an agent computer process (not shown) and/or a rule computer process (not shown).

In one embodiment, a process for providing relevant coupons at the point of sale, such as process for providing relevant coupons at the point of sale 200, and/or a computing system implemented financial management system, such as a computing system implemented financial management system 180, and/or a computing system implemented point-of-sale system 190, such as computing system implemented point-of-sale system 190, and/or data representing coupons and/or other marketing devices, are computer applications or processes and/or data implemented and/or run and/or stored, in full, or in part, in, or on, a computer program product. Herein, a computer program product comprises a medium and/or I/O device configured to store or transport computer readable code, whether available or known at the time of filing or as later developed. Some examples of computer program products are CDs, DVDs, ROM cards, floppy discs, magnetic tapes, computer hard drives, portable hard drives, flash memory, volatile and non-volatile memory sticks, servers on a network, such as server system 120 of FIG. 1, and signals transmitted over a network, such as network 130 of FIG. 1, or other media or process capable of delivering computer readable data representing computer readable code, whether available or known at the time of filing or as later developed. This medium may belong to a computing system, such as computing system 100 and computing system 150 of FIG. 1, described above. However, in some embodiments, the medium also may be removable and/or remote from the computing system.

For example, all, or part, of a process for providing relevant coupons at the point of sale, such as process for providing relevant coupons at the point of sale 200, and/or a computing system implemented financial management system, such as a computing system implemented financial management system 180, and/or a computing system implemented point-of-sale system, such as computing system implemented point-of-sale system 190, and/or data representing coupons and/or other marketing devices, may be stored in a memory that is physically located in a location, such as server system memory 123, or database 170, of FIG. 1, different from a computing system, such as computing system 100 and computing system 150 of FIG. 1, utilizing a process for providing relevant coupons at the point of sale, and/or a computing system implemented financial management system, and/or a computing system implemented point-of-sale system, and/or data representing coupons and/or other marketing devices. In one embodiment, all, or part, of a process for providing relevant coupons at the point of sale, and/or a computing system implemented financial management system, and/or a computing system implemented point-of-sale system, and/or data representing coupons and/or other marketing devices, may be stored in a memory that is physically located, separate from the computing system's processor(s), such as CPUs 101 and 151 of FIG. 1, and the computing system CPUs can be coupled to the memory in a client-server system, such as server system 120 of FIG. 1, or, alternatively, via connection to another computer, such as computing system 100 and computing system 150 of FIG. 1, via modems and analog lines, digital interfaces and a digital carrier line, or wireless or cellular connections.

In one embodiment, the computing systems and/or server systems, such as computing system 100 and/or computing system 150 and/or server system 120 of FIG. 1, running and/or utilizing and/or storing all, or part, of a process for providing relevant coupons at the point of sale, such as process for providing relevant coupons at the point of sale 200, and/or a computing system implemented financial management system, such as a computing system implemented financial management system 180, and/or a computing system implemented point-of-sale system, such as computing system implemented point-of-sale system 190, is a portable computer, a workstation, a two-way pager, a cellular telephone, a smart phone, a digital wireless telephone, a PDA, a server computer, an Internet appliance, or any other device that includes components that can execute all, or part, of a process for providing relevant coupons at the point of sale, and/or a computing system implemented financial management system, and/or a computing system implemented point-of-sale system, in accordance with at least one of the embodiments as described herein. Similarly, in another embodiment, a process for providing relevant coupons at the point of sale, and/or a computing system implemented financial management system, and/or a computing system implemented point-of-sale system, may be implemented on, and/or run on/by, and/or stored on, a computing system and/or server system that is comprised of multiple different computers, wireless devices, cellular telephones, digital telephones, two-way pagers, personal digital assistants, server computers, or any desired combination of these devices, that are coupled to perform the processes and/or operations as described herein.

### Process

Herein, the terms “user”, “consumer”, “individual”, and/or “customer” are used interchangeably to denote any party interfacing and/or interacting with a process for providing relevant coupons at the point of sale, and/or a person who is the subject, or target, of all, or part of, any data/information and/or data representing coupons obtained/provided by a process for providing relevant coupons at the point of sale, and/or a legal guardian of a person who is the subject, or target, of any data/information and/or data representing coupons obtained/provided by a process for providing relevant coupons at the point of sale, and/or an authorized agent of any party interfacing and/or interacting with a process for providing relevant coupons at the point of sale, and/or a person who is the subject, or target, of any data/information and/or data representing coupons obtained/provided by a process for providing relevant coupons at the point of sale, and/or any other authorized party associated with any party interfacing and/or interacting with a process for providing relevant coupons at the point of sale, and/or a person who is the subject, or target, of any data/information and/or data representing coupons obtained/provided by a process for providing relevant coupons at the point of sale.

Herein, the term “coupon” is used to denote coupons, discount certificates, discount vouchers, sales offers, and/or any other marketing tool and/or device that is presented and/or offered to a user.

As used herein, the term computing system implemented financial management system includes, but is not limited to: computing system implemented personal and small business financial management systems, packages, programs, modules, or applications; computing system implemented business systems, packages, programs, modules, or applications; computing system implemented tax preparation systems, packages, programs, modules, or applications; computing system implemented accounting and/or invoicing systems, packages, programs, modules, or applications; and various other electronic transaction driven data management systems, packages, programs, modules, or applications, whether known at the time of filling or as developed later.

As used herein, the term computing system implemented point-of-sale system includes, but is not limited to, any system used to conduct business transactions and perform various sales functions, including, but not limited to, any of the following: cash register functions; generate receipts; categorize transactions; interface with inventory and/or accounting modules/applications; and/or create and/or store detailed transactional data regarding sales for accounting and/or tax purposes.

As used herein, the term “coupon database” is used to define any data storage mechanism known at the time of filing or as developed thereafter, such as, but not limited to: a data storage device, a designated server system or computing system, or a designated portion of one or more server systems or computing systems, a mobile computing system, a server system network, a distributed database, or an external and/or portable hard drive. Herein, the term “coupon database” can refer to a dedicated mass storage device implemented in software, hardware, or a combination of hardware and software. Herein, the term “coupon database” can refer to a web-based function. Herein, the term “coupon database” can refer to a data storage means that is part of, or under the control of, any computing system, including, but not limited to, a desktop computing system; a laptop computing system; a cellular telephone, a smart phone, a digital wireless telephone, a Personal Digital Assistant (PDA), a hand held computer, any portable computer, any portable workstation, a two-way pager, any Internet appliance/device, or any other device, or any desired combination of devices, that includes a capability for receiving and/or storing data whether known at the time of filing or as developed thereafter.

In accordance with one embodiment, a system and method for providing relevant coupons at the point of sale includes a process for providing relevant coupons at the point of sale whereby a coupon database is provided with at least a portion of the coupon database, and the coupon data in that portion, being associated with a given user. Electronic data representing one or more coupons, and/or other marketing devices, associated with, and/or offered to, the given user is then provided to the coupon database and stored in the portion of the database associated with the user. In one embodiment, a computing system implemented point-of-sale system is then given access to the coupon database and/or the portion of the database associated with the user. In one embodiment, data and/or search parameters from the computing system implemented point-of-sale system are then used to search the portion of the database associated with the user to find any relevant coupons applicable to the user's current transaction being conducted through the computing system implemented point-of-sale system. In one embodiment, any relevant coupons are provided to the user and/or are automatically applied to the current transaction.

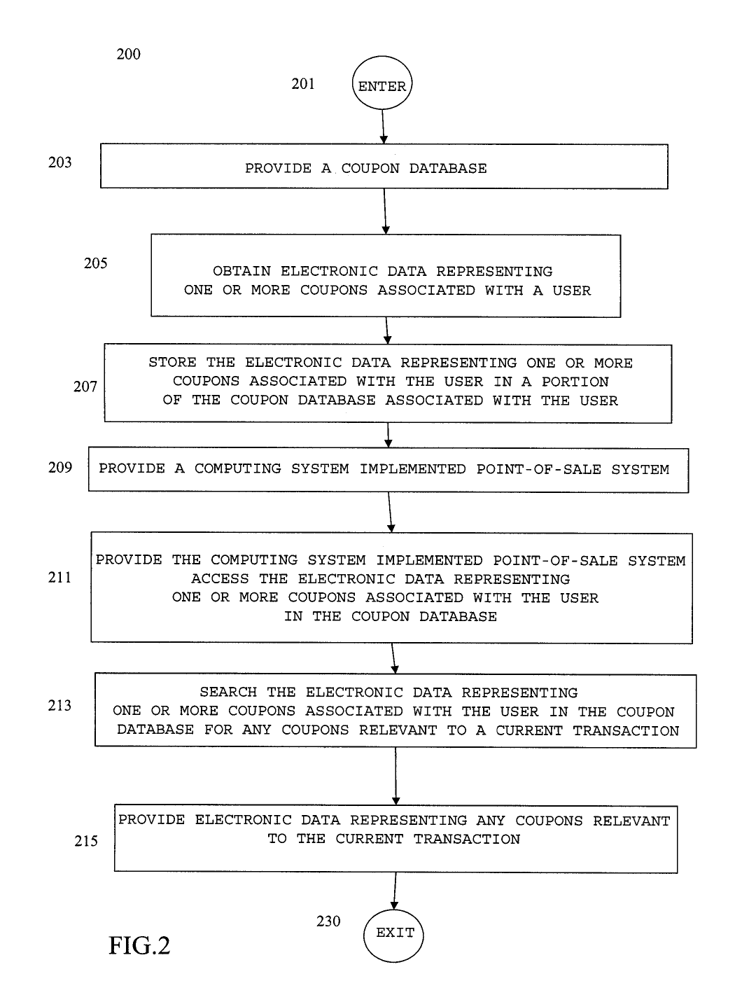

FIG. 2 a flow chart depicting a process for providing relevant coupons at the point of sale 200 in accordance with one embodiment. Process for providing relevant coupons at the point of sale 200 begins at ENTER OPERATION 201 of FIG. 2 and process flow proceeds to PROVIDE A COUPON DATABASE OPERATION 203.

In one embodiment, at PROVIDE A COUPON DATABASE OPERATION 203 a coupon database is provided with at least a portion of the coupon database being associated with a given user.

In one embodiment, the coupon database provided at PROVIDE A COUPON DATABASE OPERATION 203 is a data storage device, such as database 170 of FIG. 1, a designated server system, such as server system 120 of FIG. 1, a computing system, such as computing systems 100 and/or 150 of FIG. 1, a designated portion of one or more server systems or computing systems, a mobile computing system, a server system network, a distributed database, a memory stick, flash memory, or an external and/or portable hard drive. Returning to FIG. 2, in one embodiment, the coupon database provided at PROVIDE A COUPON DATABASE OPERATION 203 is a dedicated mass storage device implemented in software, hardware, or a combination of hardware and software. In one embodiment, the coupon database provided at PROVIDE A COUPON DATABASE OPERATION 203 is a web-based function. In one embodiment, the coupon database provided at PROVIDE A COUPON DATABASE OPERATION 203 is part of, or under the control of, any computing system, including, but not limited to, a desktop computing system; a laptop computing system; a cellular telephone, a smart phone, a digital wireless telephone, a Personal Digital Assistant (PDA), a hand held computer, any portable computer, any portable workstation, a two-way pager, any Internet appliance/device, a digital camera, or any other device, or any desired combination of devices, that includes a capability for receiving and/or storing data whether known at the time of filing or as developed thereafter.

In one embodiment, once a coupon database is provided with at least a portion of the coupon database being associated with a given user at PROVIDE A COUPON DATABASE OPERATION 203, process flow proceeds to OBTAIN ELECTRONIC DATA REPRESENTING ONE OR MORE COUPONS ASSOCIATED WITH A USER OPERATION 205.

In one embodiment, at OBTAIN ELECTRONIC DATA REPRESENTING ONE OR MORE COUPONS ASSOCIATED WITH A USER OPERATION 205 electronic data representing one or more coupons, and/or other marketing devices, such as discount vouchers, discount certificates, or specific price vouchers, associated with, and/or offered to, the given user is created and/or obtained.

In one embodiment, the electronic data representing one or more coupons, and/or other marketing devices, is created and/or obtained at OBTAIN ELECTRONIC DATA REPRESENTING ONE OR MORE COUPONS ASSOCIATED WITH A USER OPERATION 205 by scanning traditional hard copy coupons into a computing system, such as computing system 100 of FIG. 1, and then storing the electronic data representing one or more coupons in whole, or in part, in the coupon database of PROVIDE A COUPON DATABASE OPERATION 203.

As noted above, while traditionally coupons have been distributed in mostly hard-copy form by various means discussed above, more recently, coupons have been offered by, and/or through, various computing system implemented financial management systems and/or using electronic means and electronic data formats such as, but not limited to: networks of computing systems, including public networks such as the Internet; through and/or on web-sites; by e-mail; as electronic coupon attachments to electronic receipts; as electronic coupon attachments to transactional data, such as, but not limited to, transactional data from and/or displayed by a computing system implemented financial management system, banks, credit card companies, and other financial institutions; and/or as an electronic coupon attachment to virtually any electronic document and/or data and/or display. Consequently, electronic data representing one or more coupons, and/or other marketing devices, is rapidly overtaking traditional coupon forms as the dominant coupon format.

In one embodiment, the electronic data representing one or more coupons, and/or other marketing devices, is obtained at OBTAIN ELECTRONIC DATA REPRESENTING ONE OR MORE COUPONS ASSOCIATED WITH A USER OPERATION 205 by process for providing relevant coupons at the point of sale 200 directly from one or more coupon providers. As discussed below, in one embodiment, the electronic data representing one or more coupons is then stored, in whole, or in part, in the coupon database of PROVIDE A COUPON DATABASE OPERATION 203, such as database 170 of FIG. 1, under the control of, maintained by, and/or associated with: process for providing relevant coupons at the point of sale 200 (FIG. 2), and/or a provider of process for providing relevant coupons at the point of sale 200; a computing system implemented financial management system associated with process for providing relevant coupons at the point of sale 200, and/or a provider of a computing system implemented financial management system; a coupon provider; a third party data storage institution; a provider of products and/or services; any third party service or institution; or any other parties.

In one embodiment, the electronic data representing one or more coupons, and/or other marketing devices, is created and/or obtained at OBTAIN ELECTRONIC DATA REPRESENTING ONE OR MORE COUPONS ASSOCIATED WITH A USER OPERATION 205 using, or through, a computing system implemented financial management system. In one embodiment, the electronic data representing one or more coupons is then processed and/or categorized by the computing system implemented financial management system. As discussed below, in one embodiment, the data is then stored, in whole, or in part, in the coupon database of PROVIDE A COUPON DATABASE OPERATION 203, such as database 170 of FIG. 1, under the control of, maintained by, and/or associated with: process for providing relevant coupons at the point of sale 200 (FIG. 2), and/or a provider of process for providing relevant coupons at the point of sale 200; a computing system implemented financial management system, and/or a provider of a computing system implemented financial management system; a provider of products and/or services; a coupon provider; a third party data storage institution; any third party service or institution; or any other parties.

In one embodiment, the computing system implemented financial management system can be, but is not limited to, any of the following: a computing system implemented personal financial management system; a computing system implemented home inventory system; a computing system implemented business inventory system; a computing system implemented point-of-sale system; a computing system implemented personal asset management system; a computing system implemented business asset management system; a computing system implemented personal accounting system; a computing system implemented business accounting system; a computing system implemented tax preparation system; and/or any of the numerous computing system implemented financial management systems known to those of skill in the art.

In one embodiment, the electronic data representing one or more coupons, and/or other marketing devices, is created and/or obtained at OBTAIN ELECTRONIC DATA REPRESENTING ONE OR MORE COUPONS ASSOCIATED WITH A USER OPERATION 205 from user input through a user interface device such as keyboard 107, 157, mouse 111, 161 of FIG. 1 or a touchpad, voice command recognition system, or any other device capable of providing user input to a computing system or for translating user actions into computing system operations, whether available or known at the time of filing or as developed thereafter. As discussed below, in one embodiment, the data is then stored, in whole, or in part, in the coupon database of PROVIDE A COUPON DATABASE OPERATION 203, such as database 170 of FIG. 1, under the control of, maintained by, and/or associated with: process for providing relevant coupons at the point of sale 200 (FIG. 2), and/or a provider of process for providing relevant coupons at the point of sale 200; a computing system implemented financial management system, and/or a provider of a computing system implemented financial management system; a provider of products and/or services; a coupon provider; a third party data storage institution; any third party service or institution; or any other parties.

In one embodiment, the electronic data representing one or more coupons, and/or other marketing devices, is created and/or obtained at OBTAIN ELECTRONIC DATA REPRESENTING ONE OR MORE COUPONS ASSOCIATED WITH A USER OPERATION 205 from any combination of the above sources, and/or from any other source, or using, or through, any method, means, mechanism, process or procedure for creating electronic data representing one or more coupons, and/or other marketing devices, and/or through any method, apparatus, process or mechanism for transferring data, images, screen displays, and/or text from one or more devices, mobile computing systems, computing systems, server systems, databases, web site/web functions and/or any devices having a data storage capability to one or more other devices, computing systems, server systems, databases, web site/web functions and/or any devices having a data storage and/or display capability, whether known at the time of filing or as thereafter developed. As discussed below, in one embodiment, the data is then stored, in whole, or in part, in the coupon database of PROVIDE A COUPON DATABASE OPERATION 203, such as database 170 of FIG. 1, under the control of, maintained by, and/or associated with: process for providing relevant coupons at the point of sale 200 (FIG. 2), and/or a provider of process for providing relevant coupons at the point of sale 200; a computing system implemented financial management system, and/or a provider of a computing system implemented financial management system; a provider of products and/or services; a coupon provider; a third party data storage institution; any third party service or institution; or any other parties.

In one embodiment, once electronic data representing one or more coupons, and/or other marketing devices, such as discount vouchers, discount certificates, or specific price vouchers, associated with, and/or offered to, the given user is created and/or obtained at OBTAIN ELECTRONIC DATA REPRESENTING ONE OR MORE COUPONS ASSOCIATED WITH A USER OPERATION 205, process flow proceeds to STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207.

In one embodiment, at STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207 the electronic data representing one or more coupons, and/or other marketing devices, such as discount vouchers, discount certificates, or specific price vouchers, associated with, and/or offered to, the given user created and/or obtained at OBTAIN ELECTRONIC DATA REPRESENTING ONE OR MORE COUPONS ASSOCIATED WITH A USER OPERATION 205 is then provided to the coupon database of PROVIDE A COUPON DATABASE OPERATION 203 and stored in the portion of the coupon database associated with the user.

As discussed above, in one embodiment, at STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207, the electronic data representing one or more coupons, and/or other marketing devices, of OBTAIN ELECTRONIC DATA REPRESENTING ONE OR MORE COUPONS ASSOCIATED WITH A USER OPERATION 205 is stored in whole, or in part, in the coupon database of PROVIDE A COUPON DATABASE OPERATION 203, maintained by, accessible by, owned by, or otherwise related to: process for providing relevant coupons at the point of sale 200, and/or a provider of process for providing relevant coupons at the point of sale 200; a computing system implemented financial management system, and/or a provider of a computing system implemented financial management system; a provider of products and/or services; a coupon provider; or any other party, by any one of the numerous mechanisms known to those of skill in the art.

For instance, in one embodiment, the data, in whole, or in part, is stored in a coupon database of PROVIDE A COUPON DATABASE OPERATION 203 that is a memory system, such as memory system 103/153 or server memory system 123, or database 170, of FIG. 1, or in a cache memory, such as cache memory 103A/153A of FIG. 1, or in any main memory or mass memory, associated with a computing system, such as computing system 100 or computing system 150 described above. In one embodiment, the data, in whole, or in part, is stored in a coupon database of PROVIDE A COUPON DATABASE OPERATION 203 that is any computing system and/or server system, such as computing system 100, or computing system 150, or server system 120, or other device, in another location, or on/in a computer readable medium, and/or any other computer program product, as defined herein. In one embodiment, the data, in whole, or in part, is stored in a coupon database of PROVIDE A COUPON DATABASE OPERATION 203 that is a webpage, in a web-based system, or on a public network such as the Internet.

Returning to FIG. 2, as also discussed above, in some embodiments, at STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207, the electronic data representing one or more coupons, and/or other marketing devices of OBTAIN ELECTRONIC DATA REPRESENTING ONE OR MORE COUPONS ASSOCIATED WITH A USER OPERATION 205, stored as described above in the coupon database of PROVIDE A COUPON DATABASE OPERATION 203, is maintained, in whole, or in part, by: process for providing relevant coupons at the point of sale 200, and/or a provider of process for providing relevant coupons at the point of sale 200; a provider of products and/or services; a computing system implemented financial management system, and/or a provider of a computing system implemented financial management system; a coupon provider; a third party data storage institution; any third party service or institution; or any other parties.

In one embodiment, once the electronic data representing one or more coupons, and/or other marketing devices, such as discount vouchers, discount certificates, or specific price vouchers, associated with, and/or offered to, the given user created and/or obtained at OBTAIN ELECTRONIC DATA REPRESENTING ONE OR MORE COUPONS ASSOCIATED WITH A USER OPERATION 205 is provided to the coupon database of PROVIDE A COUPON DATABASE OPERATION 203 and stored in the portion of the coupon database associated with the user at STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207, process flow proceeds to PROVIDE A COMPUTING SYSTEM IMPLEMENTED POINT-OF-SALE SYSTEM OPERATION 209.

In one embodiment, at PROVIDE A COMPUTING SYSTEM IMPLEMENTED POINT-OF-SALE SYSTEM OPERATION 209 a computing system implemented point-of-sale system, such as computing system implemented point-of-sale system 190 of FIG. 1, is provided. Returning to FIG. 2, computing system implemented point-of-sale systems are typically used by product and/or service providers, such as retailers, to conduct business transactions and perform various sales functions, including, but not limited to, any of the following: cash register functions; generate receipts; categorize transactions; interface with inventory and/or accounting modules/applications; and/or create and store detailed transactional data regarding sales for accounting and/or tax purposes. In one embodiment, the computing system implemented point-of-sale system of PROVIDE A COMPUTING SYSTEM IMPLEMENTED POINT-OF-SALE SYSTEM OPERATION 209 is any one of numerous computing system implemented point-of-sale systems currently available that has the ability, and/or is modified to have the ability, to link and/or communicate with the coupon database PROVIDE A COUPON DATABASE OPERATION 203.

In one embodiment, once a computing system implemented point-of-sale system is provided at PROVIDE A COMPUTING SYSTEM IMPLEMENTED POINT-OF-SALE SYSTEM OPERATION 209, process flow proceeds to PROVIDE THE COMPUTING SYSTEM IMPLEMENTED POINT-OF-SALE SYSTEM ACCESS THE ELECTRONIC DATA REPRESENTING ONE OR MORE COUPONS ASSOCIATED WITH THE USER IN THE COUPON DATABASE OPERATION 211.

In one embodiment, at PROVIDE THE COMPUTING SYSTEM IMPLEMENTED POINT-OF-SALE SYSTEM ACCESS THE ELECTRONIC DATA REPRESENTING ONE OR MORE COUPONS ASSOCIATED WITH THE USER IN THE COUPON DATABASE OPERATION 211 the user is identified and the computing system implemented point-of-sale system of PROVIDE A COMPUTING SYSTEM IMPLEMENTED POINT-OF-SALE SYSTEM OPERATION 209 is given access to the portion of the coupon database associated with the user from STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207.

In one embodiment, at PROVIDE THE COMPUTING SYSTEM IMPLEMENTED POINT-OF-SALE SYSTEM ACCESS THE ELECTRONIC DATA REPRESENTING ONE OR MORE COUPONS ASSOCIATED WITH THE USER IN THE COUPON DATABASE OPERATION 211 the user is identified in order to determine the coupon database and/or the portion of the database associated with the user.

In one embodiment, at PROVIDE THE COMPUTING SYSTEM IMPLEMENTED POINT-OF-SALE SYSTEM ACCESS THE ELECTRONIC DATA REPRESENTING ONE OR MORE COUPONS ASSOCIATED WITH THE USER IN THE COUPON DATABASE OPERATION 211 the user is identified by the computing system implemented point of sale system of PROVIDE A COMPUTING SYSTEM IMPLEMENTED POINT-OF-SALE SYSTEM OPERATION 209 by any one of numerous methods, including, but not limited to: a card, and/or key chain device, and/or other mechanism, associated with the user and/or issued by the provider of products and/or services implementing and/or operating the computing system implemented point-of-sale system; all or part of the account number on the user's credit and/or debit card, or other device, being used to pay for the transaction; all or part of the user's telephone number, or similar unique identification number, as supplied by the user, in one embodiment through a user interface device such as a keypad and/or touch screen, and, in one embodiment, at the point of sale; using a Personal Identification Number (PIN), or similar mechanism, provided by the user, in one embodiment, at the point of sale, and, in one embodiment through a user interface device such as a keypad and/or touch screen; and/or any other mechanism, known at the time of filing or as developed thereafter, for identifying a user.

In one embodiment, once the user is identified at PROVIDE THE COMPUTING SYSTEM IMPLEMENTED POINT-OF-SALE SYSTEM ACCESS THE ELECTRONIC DATA REPRESENTING ONE OR MORE COUPONS ASSOCIATED WITH THE USER IN THE COUPON DATABASE OPERATION 211, the computing system implemented point-of-sale system of PROVIDE A COMPUTING SYSTEM IMPLEMENTED POINT-OF-SALE SYSTEM OPERATION 209 is given access to the portion of the coupon database associated with the user from STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207 either directly, or through a computing system implemented financial management system, via a network connection, such as a wireless Internet connection or other network connection, at the time of the transaction.

In one embodiment, at PROVIDE THE COMPUTING SYSTEM IMPLEMENTED POINT-OF-SALE SYSTEM ACCESS THE ELECTRONIC DATA REPRESENTING ONE OR MORE COUPONS ASSOCIATED WITH THE USER IN THE COUPON DATABASE OPERATION 211 the computing system implemented point-of-sale system of PROVIDE A COMPUTING SYSTEM IMPLEMENTED POINT-OF-SALE SYSTEM OPERATION 209 is given access to the portion of the coupon database associated with the user from STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207 either directly, or through a computing system implemented financial management system, using a network, such as network 130 of FIG. 1. As noted above, network 130 can be any network or network system that is of interest to a user such as, a wireless, wired, and/or a wireless and wired combination network, including a peer-to-peer network, a hybrid peer-to-peer network, a Local Area Network (LAN), a Wide Area Network (WAN), a public network, such as the Internet, a private network, or a combination of different network types, capable of allowing communication between two or more computing systems, whether available or known at the time of filing or as later developed.

In one embodiment, at PROVIDE THE COMPUTING SYSTEM IMPLEMENTED POINT-OF-SALE SYSTEM ACCESS THE ELECTRONIC DATA REPRESENTING ONE OR MORE COUPONS ASSOCIATED WITH THE USER IN THE COUPON DATABASE OPERATION 211 the computing system implemented point-of-sale system of PROVIDE A COMPUTING SYSTEM IMPLEMENTED POINT-OF-SALE SYSTEM OPERATION 209 is given access to the portion of the coupon database associated with the user from STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207 by providing the mobile computing system access to data on any of the storage mechanisms discussed above with respect to OBTAIN ELECTRONIC DATA REPRESENTING ONE OR MORE COUPONS ASSOCIATED WITH A USER OPERATION 205 and STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207.

In one embodiment, at PROVIDE THE COMPUTING SYSTEM IMPLEMENTED POINT-OF-SALE SYSTEM ACCESS THE ELECTRONIC DATA REPRESENTING ONE OR MORE COUPONS ASSOCIATED WITH THE USER IN THE COUPON DATABASE OPERATION 211 the computing system implemented point-of-sale system of PROVIDE A COMPUTING SYSTEM IMPLEMENTED POINT-OF-SALE SYSTEM OPERATION 209 is given access to the portion of the coupon database associated with the user from STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207 via a wireless, wired, and/or a wireless and wired combination network or any other method, means, mechanism, process or procedure for providing access to data, images, screen displays, and/or text to one or more devices, computing systems, mobile computing systems, server systems, databases, web site/web functions and/or any devices having a data storage capability from one or more other devices, mobile computing systems, computing systems, server systems, databases, web site/web functions and/or any devices having a data storage and/or display capability, whether known at the time of filing or as thereafter developed.

In one embodiment, once the user is identified and the computing system implemented point-of-sale system of PROVIDE A COMPUTING SYSTEM IMPLEMENTED POINT-OF-SALE SYSTEM OPERATION 209 is given access to the portion of the coupon database associated with the user from STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207 at PROVIDE THE COMPUTING SYSTEM IMPLEMENTED POINT-OF-SALE SYSTEM ACCESS THE ELECTRONIC DATA REPRESENTING ONE OR MORE COUPONS ASSOCIATED WITH THE USER IN THE COUPON DATABASE OPERATION 211, process flow proceeds to SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213.

In one embodiment, at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213 data and/or search parameters are then used to search the portion of the database of PROVIDE A COUPON DATABASE OPERATION 203 associated with the user and the data of OBTAIN ELECTRONIC DATA REPRESENTING ONE OR MORE COUPONS ASSOCIATED WITH A USER OPERATION 205 and STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207 to find any relevant coupons applicable to the user's current transaction being conducted through the computing system implemented point-of-sale system of PROVIDE A COMPUTING SYSTEM IMPLEMENTED POINT-OF-SALE SYSTEM OPERATION 209.

In one embodiment, at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213 the data and/or search parameters are defined by the computing system implemented point-of-sale system. For instance, in one embodiment, the data and/or search parameters are defined by the computing system implemented point-of-sale system based on the point of sale and/or the retailer where the transaction is taking place. As an example, all coupons applicable to the point of sale are searched for at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213. In one embodiment, the data and/or search parameters are defined by the computing system implemented point-of-sale system based on the items being purchased and/or “level three” data from the computing system implemented point-of-sale system. As an example, all coupons for any and all specific items being purchased may be searched for at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213.

In one embodiment, the data and/or search parameters are defined by the process for providing relevant coupons at the point of sale at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213.

In one embodiment, the data and/or search parameters are defined by the provider of products and/or services implementing and/or operating the computing system implemented point-of-sale system at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213. For instance, in one example, a given provider of products and/or services implementing and/or operating the computing system implemented point-of-sale system, may determine to accept competitor coupons, and/or exclude some coupons, from at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213.

In one embodiment, the data and/or search parameters are defined at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213 by the provider of the coupon database. In one embodiment, the data and/or search parameters are defined at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213 by the coupon provider. In one embodiment, the data and/or search parameters are defined at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213 by the user. In one embodiment, the data and/or search parameters are defined at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213 by any other party. In one embodiment, the data and/or search parameters are defined at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213 by any combination of the above parties/means.

In one embodiment, once the data and/or search parameters are provided and/or defined at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213, the data and/or search parameters are then used to search the portion of the coupon database of PROVIDE A COUPON DATABASE OPERATION 203 associated with the user and the data of OBTAIN ELECTRONIC DATA REPRESENTING ONE OR MORE COUPONS ASSOCIATED WITH A USER OPERATION 205 and STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207 to find any relevant coupons available to the user that are also applicable to the user's current transaction being conducted through the computing system implemented point-of-sale system of PROVIDE A COMPUTING SYSTEM IMPLEMENTED POINT-OF-SALE SYSTEM OPERATION 209.

In one embodiment, once the data and/or search parameters are provided and/or defined and the data and/or search parameters are used to search the portion of the database of PROVIDE A COUPON DATABASE OPERATION 203 associated with the user and the data of OBTAIN ELECTRONIC DATA REPRESENTING ONE OR MORE COUPONS ASSOCIATED WITH A USER OPERATION 205 and STORE THE ELECTRONIC DATA REPRESENTING ONE OR MORE COUPONS ASSOCIATED WITH THE USER IN A PORTION OF THE COUPON DATABASE ASSOCIATED WITH THE USER OPERATION 207 to find any relevant coupons applicable to the user's current transaction being conducted through the computing system implemented point-of-sale system of PROVIDE A COMPUTING SYSTEM IMPLEMENTED POINT-OF-SALE SYSTEM OPERATION 209 at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213, process flow proceeds to PROVIDE ELECTRONIC DATA REPRESENTING ANY COUPONS RELEVANT TO THE CURRENT TRANSACTION 215.

In one embodiment, at PROVIDE ELECTRONIC DATA REPRESENTING ANY COUPONS RELEVANT TO THE CURRENT TRANSACTION 215, data representing any relevant coupons found at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213 are provided to the user and/or are automatically applied to the current transaction.

In one embodiment, at PROVIDE ELECTRONIC DATA REPRESENTING ANY COUPONS RELEVANT TO THE CURRENT TRANSACTION 215, any relevant coupons found as a result of the search of the coupon database at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213 are provided and/or submitted to the user, and/or the provider of products and/or services implementing and/or operating the computing system implemented point-of-sale system, for approval prior to being applied to the current transaction.

In one embodiment, at PROVIDE ELECTRONIC DATA REPRESENTING ANY COUPONS RELEVANT TO THE CURRENT TRANSACTION 215, any relevant coupons found as a result of the search of the coupon database at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213 are automatically applied to the current transaction.

In one embodiment, at PROVIDE ELECTRONIC DATA REPRESENTING ANY COUPONS RELEVANT TO THE CURRENT TRANSACTION 215, any relevant coupons found as a result of the search of the coupon database at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213 are displayed on a display device of a computing system and/or the electronic data representing one or more coupons, and/or other marketing devices, is submitted to the seller at the point of sale, and at the time of the purchase of the product and/or service that is the subject of the coupon.

In one embodiment, at PROVIDE ELECTRONIC DATA REPRESENTING ANY COUPONS RELEVANT TO THE CURRENT TRANSACTION 215, any relevant coupons found as a result of the search of the coupon database at SEARCH THE ELECTRONIC DATA REPRESENTING ONE OR MORE COUPONS ASSOCIATED WITH THE USER IN THE COUPON DATABASE FOR ANY COUPONS RELEVANT TO A CURRENT TRANSACTION OPERATION 213 are provided using, or through, any method, means, mechanism, process or procedure for creating electronic data representing one or more coupons, and/or other marketing devices, and/or through any method, apparatus, process or mechanism for transferring data, images, screen displays, and/or text from one or more devices, mobile computing systems, computing systems, server systems, databases, web site/web functions and/or any devices having a data storage capability to one or more other devices, computing systems, server systems, databases, web site/web functions and/or any devices having a data storage and/or display capability, whether known at the time of filing or as thereafter developed.

In one embodiment, once any relevant coupons are provided to the user and/or are automatically applied to the current transaction at PROVIDE ELECTRONIC DATA REPRESENTING ANY COUPONS RELEVANT TO THE CURRENT TRANSACTION 215 process flow proceeds to EXIT OPERATION 230. In one embodiment, at EXIT OPERATION 230 process for providing relevant coupons at the point of sale 200 is exited to await a new coupon, and/or new parameters, and/or new transaction data.

Using process for providing relevant coupons at the point of sale 200, electronic data representing one or more coupons, and/or other marketing devices, is stored in a coupon database and/or the portion of a coupon database associated with the user. The coupon database and/or the portion of a coupon database associated with the user is then made available to a computing system implemented point-of-sale system, in one embodiment, at the point of sale, for use with a transaction currently being conducted through the computing system implemented point-of-sale system. Therefore, using process for providing relevant coupons at the point of sale 200, the consumer can obtain, and use, electronic coupons relating to their purchases virtually anytime and anywhere. As result, process for providing relevant coupons at the point of sale 200 spares the consumer the process of: searching for a relevant coupon; obtaining a hard-copy of the coupon, either by cutting it out of a printed document or printing a copy out on a printer; saving/storing the hard copy of the coupon until used; and the need to carry with them, and supply, the hard copy of the coupon when they actually attempt to make a purchase. As a result, using process for providing relevant coupons at the point of sale 200, the consumer is more likely to benefit from coupon offers and the goals of the coupon providers are also more likely to be met.

As discussed in more detail above, using the above embodiments, with little or no modification and/or user input, there is considerable flexibility, adaptability, and opportunity for customization to meet the specific needs of various users under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, and/or protocols. Further, the system and/or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic and/or algorithm-like descriptions and representations are the means used by those of skill in the art to most effectively and efficiently convey the substance of their work to others of skill in the art. These operations, while described functionally or logically, are understood to be implemented by computer programs and/or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “accessing”, “analyzing”, “obtaining”, “determining”, “collecting”, “creating”, “transferring”, “storing”, “searching”, “comparing”, “providing”, etc., refer to the action and processes of a computing system or similar electronic device that manipulates and operates on data represented as physical (electronic) quantities within the computing system memories, resisters, caches or other information storage, transmission or display devices.

Certain aspects of the present invention include process steps or operations and instructions described herein in an algorithmic and/or algorithmic-like form. It should be noted that the process steps and/or operations and instructions of the present invention can be embodied in software, firmware, and/or hardware, and when embodied in software, can be downloaded to reside on and be operated from different platforms used by real time network operating systems.

The present invention also relates to an apparatus or system for performing the operations described herein. This apparatus or system may be specifically constructed for the required purposes, or the apparatus or system can comprise a general purpose system selectively activated or configured/reconfigured by a computer program stored via a computer program product as defined herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar and/or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIGS. are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented process for providing relevant coupons at the point of sale comprising:
providing a coupon database;
obtaining data representing one or more coupons, the one or more coupons being available to a user;
storing the data representing the one or more coupons available to the user in the coupon database and associating the data representing one or more coupons available to a user with the user;
providing a computing system implemented point-of-sale system;
performing a transaction with the computing system implemented point-of-sale system, the transaction involving the user;
providing the computing system implemented point-of-sale system access to the data representing the one or more coupons available to the user;
searching the data representing the one or more coupons available to the user for coupons relevant to the transaction; and
providing data representing any coupons relevant to the transaction from the one or more coupons available to the user.

2. The computing system implemented process for providing relevant coupons at the point of sale of claim 1, wherein;
providing a coupon database comprises providing a coupon database associated with a seller.

3. The computing system implemented process for providing relevant coupons at the point of sale of claim 1, wherein;
providing a coupon database comprises providing a coupon database associated with a coupon provider.

4. The computing system implemented process for providing relevant coupons at the point of sale of claim 1, wherein;
providing a coupon database comprises providing a coupon database associated with a computing system implemented financial management system.

5. The computing system implemented process for providing relevant coupons at the point of sale of claim 1, wherein;
providing a coupon database comprises providing a coupon database associated with the provider of the computing system implemented process for providing relevant coupons.

6. The computing system implemented process for providing relevant coupons at the point of sale of claim 1, wherein;
obtaining data representing one or more coupons, the one or more coupons being available to a user comprises:
scanning one or more hard copies of coupons available to the user;
storing the data representing the scanned one or more coupons available to the user in the coupon database; and
associating the data representing the scanned one or more coupons available to a user with the user.

7. The computing system implemented process for providing relevant coupons at the point of sale of claim 1, wherein;
obtaining data representing one or more coupons, the one or more coupons being available to a user comprises:
obtaining the data representing one or more coupons available to the user from one or more computing system implemented financial management systems.

8. The computing system implemented process for providing relevant coupons at the point of sale of claim 1, wherein;
obtaining data representing one or more coupons, the one or more coupons being available to a user comprises:
obtaining the data representing one or more coupons available to the user from one or more coupon providers.

9. The computing system implemented process for providing relevant coupons at the point of sale of claim 1, wherein;
searching the data representing the one or more coupons available to the user for coupons relevant to the transaction comprises searching the data representing the one or more coupons available to the user for coupons relevant to the seller.

10. The computing system implemented process for providing relevant coupons at the point of sale of claim 1, wherein;
searching the data representing the one or more coupons available to the user for coupons relevant to the transaction comprises searching the data representing the one or more coupons available to the user for coupons relevant to one or more items that are being purchased through the transaction.

11. The computing system implemented process for providing relevant coupons at the point of sale of claim 1, wherein;
providing data representing any coupons relevant to the transaction of the one or more coupons available to the user comprises providing data representing any coupons relevant to the transaction for approval prior to applying the coupons to the transaction.

12. The computing system implemented process for providing relevant coupons at the point of sale of claim 1, wherein;
providing data representing any coupons relevant to the transaction of the one or more coupons available to the user comprises providing data representing any coupons relevant to the transaction to the computing system implemented point-of-sale system for automatic application of the coupons to the transaction.

13. A system for providing relevant coupons at the point of sale comprising:
a coupon database;
a computing system implemented point-of-sale system;
and
a processor, the processor for executing one or more instructions associated with a process for providing relevant coupons at the point of sale, the process for providing relevant coupons at the point of sale comprising:
obtaining data representing one or more coupons, the one or more coupons being available to a user;
storing the data representing the one or more coupons available to the user in the coupon database; and associating the data representing one or more coupons available to a user with the user;
performing a transaction with the computing system implemented point-of-sale system, the transaction involving the user;
providing the computing system implemented point-of-sale system access to the data representing the one or more coupons available to the user;
searching the data representing the one or more coupons available to the user for coupons relevant to the transaction; and
providing data representing any coupons relevant to the transaction from the one or more coupons available to the user.

14. The system for providing relevant coupons at the point of sale of claim 13, wherein;
the coupon database is associated with a seller.

15. The system for providing relevant coupons at the point of sale of claim 13, wherein;
the coupon database is associated with a coupon provider.

16. The system for providing relevant coupons at the point of sale of claim 13, wherein;
the coupon database is associated with a computing system implemented financial management system.

17. The system for providing relevant coupons at the point of sale of claim 13, wherein;
the coupon database is associated with the provider of the computing system implemented process for providing relevant coupons.

18. The system for providing relevant coupons at the point of sale of claim 13, wherein;
obtaining data representing one or more coupons, the one or more coupons being available to a user comprises:
scanning one or more hard copies of coupons available to the user;
storing the data representing the scanned one or more coupons available to the user in the coupon database; and
associating the data representing the scanned one or more coupons available to a user with the user.

19. The system for providing relevant coupons at the point of sale of claim 13, wherein;
obtaining data representing one or more coupons, the one or more coupons being available to a user comprises:
obtaining the data representing one or more coupons available to the user from one or more computing system implemented financial management systems.

20. The system for providing relevant coupons at the point of sale of claim 13, wherein;
obtaining data representing one or more coupons, the one or more coupons being available to a user comprises:
obtaining the data representing one or more coupons available to the user from one or more coupon providers.

21. The system for providing relevant coupons at the point of sale of claim 13, wherein;
searching the data representing the one or more coupons available to the user for coupons relevant to the transaction comprises searching the data representing the one or more coupons available to the user for coupons relevant to the seller.

22. The system for providing relevant coupons at the point of sale of claim 13, wherein;
searching the data representing the one or more coupons available to the user for coupons relevant to the transaction comprises searching the data representing the one or more coupons available to the user for coupons relevant to one or more items that are being purchased through the transaction.

23. The system for providing relevant coupons at the point of sale of claim 13, wherein;
providing data representing any coupons relevant to the transaction of the one or more coupons available to the user comprises providing data representing any coupons relevant to the transaction for approval prior to applying the coupons to the transaction.

24. The system for providing relevant coupons at the point of sale of claim 13, wherein;
providing data representing any coupons relevant to the transaction of the one or more coupons available to the user comprises providing data representing any coupons relevant to the transaction to the computing system implemented point-of-sale system for automatic application of the coupons to the transaction.

25. A computing system implemented point-of-sale system comprising:
a computer readable medium;
and computer program code, encoded on the computer readable medium, comprising computer readable instructions for:
performing a transaction, the transaction involving a user;
accessing data representing one or more coupons available to the user, the data representing the one or more coupons available to the user being associated with the user and stored in a coupon database;
searching the data representing the one or more coupons available to the user for coupons relevant to the transaction; and
providing data representing any coupons relevant to the transaction from the one or more coupons available to the user.
